(19) United States
(12) Patent Application Publication
(10) Pub. No.: US 2026/0261973 A1
(43) Pub. Date: Sep. 3, 2026

(54) METHOD AND APPARATUS FOR INFORMATION DETERMINATION, AND STORAGE MEDIUM

(71) Applicant: BEIJING XIAOMI MOBILE SOFTWARE CO., LTD., Beijing (CN)

(72) Inventors: Shengxiang GUO, Beijing (CN); Ting FU, Beijing (CN); Yuanyuan LI, Beijing (CN)

(21) Appl. No.: 19/154,604

(22) PCT Filed: Feb. 10, 2023
(86) PCT No.: PCT/CN2023/075521

§ 371 Date: Aug. 7, 2025

(51) Int. Cl. H04W 52/02

(52) U.S. Cl. CPC H04W 52/0235

(57) ABSTRACT

A method for information determination, performed by a terminal in a wireless network, includes: acquiring a first reference signal; and determining an energy threshold parameter corresponding to a wake-up signal based on the first reference signal, in which, the wake-up signal is used to indicate the terminal to change a sleep state, and the energy threshold parameter is used to determine information carried by the wake-up signal. A method for information determination, performed by a network device, includes sending a wake-up signal to a terminal, wherein the wake-up signal is used to indicate the terminal to determine an energy threshold parameter corresponding to the wake-up signal based on a first reference signal, and the energy threshold parameter is used to determine information carried by the wake-up signal.

### CROSS REFERENCE TO RELATED APPLICATIONS

This application is a national phase application based on International Application No. PCT/CN2023/075521, filed on Feb. 10, 2023, the entire content of which is incorporated by reference.

### FIELD

The present disclosure relates to the field of wireless communication technology, and more particularly, to a method and an apparatus for information determination and a storage medium.

### BACKGROUND

In wireless communication systems, in order to reduce power consumption of terminals, the 3rd generation partnership project (3GPP) has introduced a wake-up signal (WUS), and the WUS may be a low power detection signal. For example, the WUS may also be referred to as a low power wake-up signal (LP WUS). In the case of detecting the WUS, the terminal may perform monitoring of a physical downlink control channel (PDCCH). In the case of not detecting the WUS, the terminal may skip monitoring of the PDCCH, such that the terminal may be in a low power sleep state, reducing the power consumption of the terminal.

In related arts, a network device may carry different information by sending WUSs with different amounts of energy, and the terminal may also acquire information carried by the WUS based on the energy of the received WUS.

### SUMMARY

According to a first aspect of embodiments of the present disclosure, there is provided a method for information determination, which is performed by a terminal and includes: acquiring a first reference signal; and determining an energy threshold parameter corresponding to a wake-up signal based on the first reference signal, in which the wake-up signal is used to indicate the terminal to change a sleep state, and the energy threshold parameter is used to determine information carried by the wake-up signal.

According to a second aspect of embodiments of the present disclosure, there is provided a method for information determination, which is performed by a network device and includes: sending a wake-up signal to a terminal, in which, the wake-up signal is used to indicate the terminal to determine an energy threshold parameter corresponding to the wake-up signal based on a first reference signal, and the energy threshold parameter is used to determine information carried by the wake-up signal.

According to a third aspect of embodiments of the present disclosure, there is provided an apparatus for information determination, which includes: a processor; and a memory configured to store instructions executable by the processor, in which the processor is configured to acquire a first reference signal, and determine an energy threshold parameter corresponding to a wake-up signal according to the first reference signal, in which, the wake-up signal is used to instruct the terminal to change a sleep state, and the energy threshold parameter is used to determine information carried by the wake-up signal.

### BRIEF DESCRIPTION OF THE DRAWINGS

The accompanying drawings herein are incorporated into the specification and constitute a part of the specification. Theses accompanying drawings illustrate embodiments conform to the present disclosure and are used to explain the principles of the present disclosure together with the specification.

FIG. 1 is a schematic diagram illustrating a communication system according to an illustrative embodiment.

FIG. 2 is a flow chart illustrating a method for information determination performed by a terminal according to an illustrative embodiment.

FIG. 3 is a flow chart illustrating a method for information determination according to an illustrative embodiment.

FIG. 4 is a flow chart illustrating a method for information determination according to an illustrative embodiment.

FIG. 5 is a flow chart illustrating a method for information determination performed by a network device according to an illustrative embodiment.

FIG. 6 is a flow chart illustrating a method for information determination according to an illustrative embodiment.

FIG. 7 is a flow chart illustrating a method for information determination according to an illustrative embodiment.

FIG. 8 is a flow chart illustrating a method for information determination according to an illustrative embodiment.

FIG. 9 is a flow chart illustrating a method for information determination according to an illustrative embodiment.

FIG. 10 is a block diagram illustrating an apparatus for information determination according to an illustrative embodiment.

FIG. 11 is a block diagram illustrating an apparatus for information determination according to an illustrative embodiment.

FIG. 12 is a block diagram illustrating an apparatus for information determination according to an illustrative embodiment.

### DETAILED DESCRIPTION

Illustrative embodiments are illustrated in detail herein, and the examples thereof are shown in the accompanying drawings. When the following description refers to the accompanying drawings, unless otherwise specified, the same or similar elements are denoted by the same numerals in the different accompanying drawings. Implementations described in the illustrative embodiments do not represent all implementations consistent with the present disclosure. On the contrary, they are merely examples of an apparatus and a method consistent with some aspects of the present disclosure, as elaborated in the appended claims.

It should be noted that all actions to obtain signals, information or data in the present disclosure are performed in compliance with the corresponding data protection regulations and policies of the country in which they are located, and with authorization granted by the owner of the corresponding apparatus.

In the description of the present disclosure, the use of terms such as “first”, “second”, etc. is used to distinguish between similar objects and need not be construed as a particular order or sequence. Further, in the absence of any explanation to the contrary, in the description with reference to the accompanying drawings, the same reference numeral in the different accompanying drawings indicates the same elements.

In the description of the present disclosure, “a plurality of” means two or more than two, and other quantifiers are similar. “at least one”, “one or more” or similar expressions refer to any combination of these items, including any combination of single or plural items. For example, at least one may denote any number, and for another example, one or more of a, b, and c may denote: a, b, c, a-b, a-c, b-c, or a-b-c, where a, b, and c may be single or plural. The term “and/or” describes the association relationship of the associated objects, and means that there can be three types of relationships. For example, A and/or B, can mean that A exists alone, A and B exist at the same time, and B exists alone, where A and B may be single or plural. The character “/” indicates that the associated objects before and after it are an “or” relationship. The singular form “a/an”, “the”, “said” and “this” is also intended to include the plural form, unless other meanings are explicitly expressed in the context.

Although the operations or steps are described in a specific order in the drawings or embodiments of the present disclosure, it should not be construed as requiring that the operations or steps be performed in the specific order shown or in a serial order, or requiring that all operations or steps shown be performed to obtain the desired result. In embodiments of the present disclosure, the operations or steps may be performed in any order without contradiction; the operations or steps may be performed in parallel; part of the operations or steps may be performed; or the operations or steps in multiple embodiments or accompanying drawings may be combined arbitrarily, which is not limited by the present disclosure.

An implementation environment for embodiments of the present disclosure is first described below.

The technical solutions of the embodiments of the present application can be applied to various communication systems. The communication system may include one or more of the 4th Generation (4G) communication system, the 5th Generation (5G) communication system, and other future wireless communication systems such as 6G. The communication system may also include one or more of a public land mobile network (PLMN) network, a device-to-device (D2D) communication system, a machine to machine (M2M) communication system, an internet of things (IoT) communication system, a vehicle-to-everything (V2X) communication system, or other communication systems.

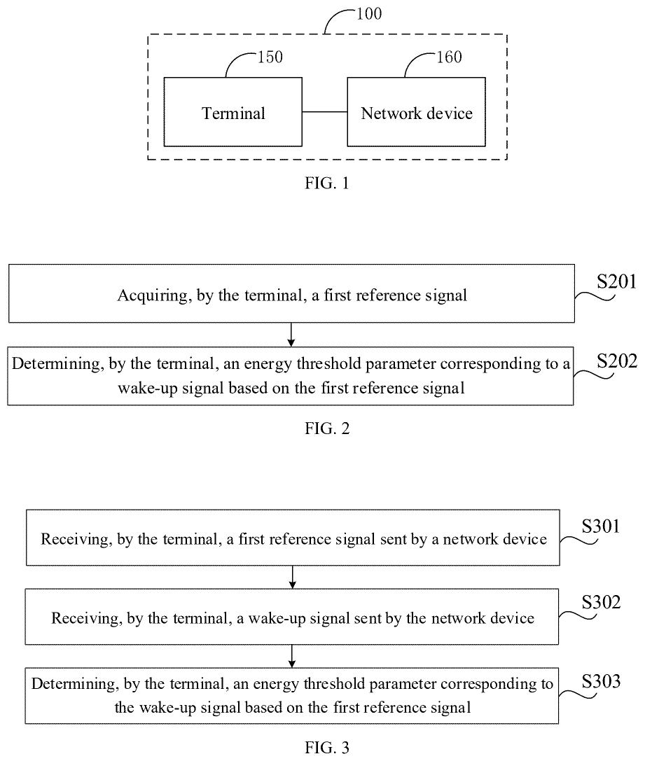

FIG. 1 is a schematic diagram illustrating a communication system 100 according to an illustrative embodiment. As illustrated in FIG. 1, the communication system 100 may include a terminal 150 and a network device 160. The communication system may be used to support 4G network access technologies, such as long term evolution (LTE) access technologies, or 5G network access technologies, such as new radio access technology (new RAT), or other future wireless communication technologies. It should be noted that in the communication system, the number of both network devices and terminals may be one or more, and the number of network devices and terminals of the communication system shown in FIG. 1 is only an adaptive example, which is not limited by the present disclosure.

The network device in FIG. 1 may be used to support terminal access, for example, the network device may be an evolutionary Node B (eNB, or eNodeB) in LTE; the network device may also be the next generation Node B (gNB, or gNodeB) in a 5G network; the network device may also be the NG-Radio Access Network (NG-RAN) device in the 5G network; the network device may also be the base station, Broadband Network Gateway (BNG), aggregation switch, or non-3GPP access device in the future evolved Public Land Mobile Network (PLMN). Optionally, the network device in embodiments of the present disclosure may include various forms of base stations, such as: macro base stations, micro base stations (also referred to as small stations), relay stations, access points, 5G base stations or future base stations, satellites, transmitting and receiving point (TRP), transmitting point (TP), mobile switching centers, and device-to-device (D2D), machine-to-machine (M2M), internet of things (IOT), vehicle-to-everything (V2X), or other devices that assume a base station function in the communication system, etc., which is not specifically limited by embodiments of the present disclosure. For convenience of description, in all embodiments of the present disclosure, devices providing wireless communication functions for terminals are collectively referred to as network devices or base stations.

The terminal in FIG. 1 may be an electronic device that provides voice or data connectivity, for example, the terminal may also be referred to as user equipment (UE), subscriber unit, mobile station, station, terminal, etc. By way of example, the terminal may include a smartphone, a smart wearable device, a smart speaker, a smart tablet, a wireless modem, a wireless local loop (WLL) station, a personal digital assistant (PDA), a customer premise equipment (CPE), and the like. With the development of wireless communication technology, devices that may be accessed to a communication system, that may communicate with a network device of a communication system, that may communicate with other objects through a communication system, or, that may communicate directly between two or more devices may be the terminals in embodiments of the present disclosure; for example, terminals and automobiles in intelligent transportation, household devices in a smart home, power meter reading instruments in smart grids, voltage monitoring instruments, environmental monitoring instruments, video monitoring instruments in intelligent security networks, cash registers, and the like. In embodiments of the present disclosure, the terminal may communicate with a network device. A plurality of terminals may also communicate with each other. The terminal may be static and fixed or mobile, which is not limited by the present disclosure.

In some embodiments of the present disclosure, the terminal in FIG. 1 may be a terminal that supports a power saving function. For example, without data reception/transmission, the terminal may be in sleep states to varying degrees. In an implementation, the sleep states of the terminal may include at least one of ultra-deep sleep, deep sleep, light sleep, micro sleep, or wake-up (normal). The terminal may change the sleep state based on an indication from a network device or control of the terminal itself, and switch between any two sleep states. For example, the terminal may switch from a micro sleep state to a deep sleep state, or from the deep sleep state to a wake-up state. Switching of the terminal from other states to the wake-up state may also be directly referred to as the terminal being awakened. It is noted that the terminal may be in the wake-up state after being awakened, and the wake-up state of the terminal may be a special form of the sleep state, or may be considered to be a different state relative to the sleep state, which is not limited in the present disclosure.

In some embodiments, in response to receiving a wake-up signal, and the wake-up signal being used to indicate to wake up the terminal, the terminal may receive downlink signaling or data, and may also send uplink signaling or data. In response to receiving no wake-up signal, or the received wake-up signal indicating not to wake up the terminal (for example, the wake-up signal indicating to wake up other terminals), the terminal may maintain a current sleep state. In response to receiving no wake-up signal, or the received wake-up signal indicating not to wake up the terminal (for example, the wake-up signal indicating to wake up other terminals), in some cases (for example, the terminal is in a non-ultra-deep sleep state, with a time reaching a certain threshold), the terminal may enter a sleep state with a deeper level.

In some embodiments, main radio of the terminal may include a main transceiver and/or a main receiver, there may be one or more main transceivers, and there may also be one or more main receivers. The terminal may perform signaling or data reception and transmission using the main radio, and the terminal may also receive the above wake-up signal through a separate receiver. The receiver for receiving the wake-up signal may be called as a low power wake-up signal receiver (low power WUS receiver), and the low-power WUS receiver may be different from the above main radio. For example, in response to receiving the wake-up signal, and the wake-up signal being used to indicate to wake-up the terminal, the terminal may turn on the main radio, receive a downlink signal and/or send an uplink signal through the main radio. In response to receiving no wake-up signal, and or the received wake-up signal indicating not to wake up the terminal (for example, the wake-up signal indicating to wake up other terminals), the terminal may maintain a current sleep state of the main radio.

In some embodiments, the network device may carry different information by sending wake-up signals with different sizes of energy, and the terminal may also determine information carried by the wake-up signal based on the size of energy of the received wake-up signal.

In some embodiments, the terminal may determine the information carried by the received wake-up signal by means of envelope detection, and the envelope detection may include amplitude detection or energy detection. For example, the terminal may determine the information carried by the wake-up signal based on an amplitude or an energy level of the received wake-up signal. A modulation mode of the wake-up signal may include a multi-carrier on-off keying (MC-OOK) modulation mode or an amplitude shift keying (ASK) modulation mode.

In some embodiments, in response to the modulation mode of the wake-up signal being the MC-OOK modulation mode, one time domain symbol of the wake-up signal may be used to carry at most two values of one bit, for example, a symbol with energy sent is an ON symbol, and the ON symbol indicates that a value of the bit is 1, and a symbol without energy sent is an OFF symbol, and the OFF symbol indicates that the value of the bit is 0. For another example, the symbol with energy sent is an ON symbol, and the ON symbol indicates that the value of the bit is 0, and the symbol without energy sent is an OFF symbol, and the OFF symbol indicates that the value of the bit is 1.

In some embodiments, in response to the modulation mode of the wake-up signal being the MC-OOK modulation mode, and a plurality of time domain symbols of the wake-up signal jointly indicating two values of one bit, the plurality of time domain symbols carry one bit.

In some embodiments, in response to the modulation mode of the wake-up signal being the ASK modulation mode, one time domain symbol of the wake-up signal can carry a plurality of bits, and different energy values are used to distinguish values representing different bits.

In some embodiments, in response to the modulation mode of the wake-up signal being the ASK modulation mode, and a plurality of time domain symbols of the wake-up signal jointly indicate two values of a plurality of bits, the plurality of time domain symbols carry a plurality of bits.

In some embodiments, information corresponding to each time domain symbol of the wake-up signal may be determined based on a predetermined energy threshold, and there may be one or more energy thresholds.

FIG. 2 is a flow chart illustrating a method for information determination according to an illustrative embodiment. The method may be performed by a terminal in the above communication system. As shown in FIG. 2, the method may include the following steps.

At step S201, the terminal acquires a first reference signal.

At step S202, the terminal determines an energy threshold parameter corresponding to a wake-up signal based on the first reference signal.

In some embodiments, the wake-up signal may be a signal sent by a network device to the terminal, and the wake-up signal may be used to indicate the terminal to change a sleep state. For example, the wake-up signal may wake up the terminal, or the wake-up signal may also indicate the terminal to change from a deep sleep state to a micro sleep state, or the wake-up signal may also indicate the terminal device to maintain a current wake-up state. Switching of the terminal from other states to the wake-up state may also be directly referred to as the terminal being awakened.

In some embodiments, the energy threshold parameter may be used to determine information carried by the wake-up signal. The information carried by the wake-up signal may include one or more bits, for example, in a case where the information includes one bit, the one bit indicates 0 or 1, and in a case where the information includes two bits, the two bits indicates 00, 01, 10, 11, etc. The terminal may determine the information carried by the wake-up signal based on the energy threshold parameter, and change or maintain the sleep state of the terminal based on the information.

There may be one or more first reception energy information. There may be a plurality of manners for the terminal to acquire the energy threshold parameter based on the first reference signal, examples of which are as follows.

In some embodiments of the present disclosure, the terminal may acquire first reception energy information of the first reference signal, and determine the energy threshold parameter of the wake-up signal according to the first reception energy information.

The first reception energy information may include a maximum energy, a minimum energy, an average energy or a specific information bit energy of the first reference signal. The specific information bit energy may be a reception energy corresponding to a specific information bit carried by the first reference signal. For example, the specific information bit may be 10 or 1100.

In some embodiments, the first reference signal may be a signal received by the terminal via at least one reference wireless resource, and the reference wireless resource may include a time domain resource, a frequency domain resource, or a time-frequency resource.

For example, the terminal may receive the first reference signal via one reference wireless resource. Similarly, the network device may also send the first reference signal via one reference wireless resource.

For another example, the terminal may receive the first reference signal via a plurality of reference wireless resources. Similarly, the network device may also send the first reference signal via a plurality of reference wireless resources.

In some embodiments, the at least one reference wireless resource may be determined by the network device and sent to the terminal.

For example, the terminal may receive a reference resource indication parameter sent by the network device, and determine a reference wireless resource for receiving the first reference signal based on the reference resource indication parameter.

In another embodiment, the at least one reference wireless resource may be predefined by a protocol.

For example, the network device may send the first reference signal based on at least one reference wireless resource predefined by the protocol. The terminal may also receive the first reference signal based on the at least one reference wireless resource predefined by the protocol.

In some embodiments, each reference wireless resource may include at least one symbol, and the terminal may acquire a reception energy corresponding to each reference wireless resource in the following manner.

In response to each reference wireless resource including one symbol, a reception energy of the symbol may be used as the reception energy corresponding to the reference wireless resource.

In response to each reference wireless resource including a plurality of symbols, a sum value or an average value of reception energies of the plurality of symbols may be used as the reception energy corresponding to the reference wireless resource.

In response to each reference wireless resource including a plurality of symbols, the plurality of symbols may be divided into a plurality of sub-reference wireless resources, and a sum value, an average value, a maximum value or a minimum value of reception energies of the sub-reference wireless resources is used as the reception energy corresponding to the reference wireless resource.

In another embodiment, each reference wireless resource may include at least one resource element (RE), and the terminal may acquire a reception energy corresponding to each reference wireless resource in the following manner.

In response to each reference wireless resource including one resource element, a reception energy of the resource element may be used as the reception energy corresponding to the reference wireless resource.

In response to each reference wireless resource including a plurality of resource elements, a sum value or an average value of reception energies of the plurality of resource elements may be used as the reception energy corresponding to the reference wireless resource.

In response to each reference wireless resource including a plurality of resource elements, the plurality of resource elements may be divided into a plurality of sub-reference wireless resources, and a sum value, an average value, a maximum value or a minimum value of reception energies of the sub-reference wireless resources is used as the reception energy corresponding to the reference wireless resource.

In another embodiment, each reference wireless resource may include at least one resource block (RB), one RB includes 12 REs, and the terminal may acquire a reception energy corresponding to each reference wireless resource in the following manner.

In response to each reference wireless resource including one resource block, a reception energy of the resource block may be used as the reception energy corresponding to the reference wireless resource.

In response to each reference wireless resource including a plurality of resource blocks, a sum value or an average value of reception energies of the plurality of resource blocks may be used as the reception energy corresponding to the reference wireless resource.

In response to each reference wireless resource including a plurality of resource blocks, the plurality of resource blocks may be divided into a plurality of sub-reference wireless resources, and a sum value, an average value, a maximum value or a minimum value of reception energies of the sub-reference wireless resources is used as the reception energy corresponding to the reference wireless resource.

In another embodiment, each reference wireless resource may include at least one time-frequency resource block, the time-frequency resource block includes at least one RE in a frequency domain and at least one symbol in a time domain, and the terminal may acquire a reception energy corresponding to each reference wireless resource in the following manner.

In response to each reference wireless resource including one time-frequency resource block, a reception energy of the time-frequency resource block may be used as the reception energy corresponding to the reference wireless resource.

In response to each reference wireless resource including a plurality of time-frequency resource blocks, a sum value or an average value of reception energies of the plurality of time-frequency resource blocks may be used as the reception energy corresponding to the reference wireless resource.

In response to each reference wireless resource including a plurality of time-frequency resource blocks, the plurality of time-frequency resource blocks may be divided into a plurality of sub-reference wireless resources, and a sum value, an average value, a maximum value or a minimum value of reception energies of the sub-reference wireless resources is used as the reception energy corresponding to the reference wireless resource.

In another embodiment, the reference wireless resource may carry a specific information bit, and the specific information bit may include a data information bit. The data information bit represents real information data and are predefined by a protocol. The data information bit at least includes one bit, and a starting value of the data information bit may be 0 or 1. For example, the data information bit may be 1100, and for another example, the data information bit may be 0011.

In another embodiment, the reference wireless resource may carry a specific information bit, and the specific information bit may include a coding information bit. The coding information bit is encoded from the data information bit. The coding information bit may include at least one bit and may be predefined by a protocol. A starting value of the coded information bit may be 0 or 1. For example, the data information bit may be 10, and a corresponding coded information bit may be 1100. For another example, the data information bit may be 01, and a corresponding coded information bit may be 110.

In some embodiments, first reception energy information corresponding to a specific information bit carried by the at least one reference wireless resource may be acquired, and the energy threshold parameter may be determined based on the first reception energy information.

For example, the reference wireless resource may be used to carry a first information bit, and the first information bit may include the above specific information bit. Different reference wireless resources may carry different first information bits. The terminal may determine a reception energy of the reference wireless resource carrying the specific information bit as the first reception energy, and determine the energy threshold parameter based on the first reception energy.

In an implementation, a maximum value of reception energies corresponding to a plurality of reference wireless resources may be determined as the first reception energy information.

In another implementation, a maximum value of accumulated energies of the reference wireless resources among the reception energies corresponding to the plurality of reference wireless resources may be determined as the first reception energy information. For example, the reference wireless resources include a first sub-reference wireless resource, a second sub-reference wireless resource, and a third sub-reference wireless resource. If an accumulated energy of the first sub-reference wireless resource is the maximum value, an accumulated energy value of the first sub-reference wireless resource may be determined as the first reception energy information.

In another implementation, an energy value corresponding to the specific information bit of the first reference signal may be determined as the first reception energy information. For example, the specific information bit carried by the first reference signal is 11, then an energy value corresponding to the specific information bit 11 may be determined as the first reception energy information.

In another implementation, an average energy value corresponding to the plurality of specific information bits of the first reference signal may be determined as the first reception energy information. For example, a first specific information bit carried by the first reference signal is 11, and a second specific information bit carried by the first reference signal is 11, then an average energy value corresponding to the first specific information bit 11 and the second specific information bit 11 may be determined as the first reception energy information.

In another implementation, a sum of energy values corresponding to the plurality of specific information bits of the first reference signal may be determined as the first reception energy information. For example, the first specific information bit carried by the first reference signal is 11, and the second specific information bit carried by the first reference signal is 11, then the sum of energy values corresponding to the first specific information bit 11 and the second specific information bit 11 may be determined as the first reception energy information.

In another implementation, a maximum value of the energy values corresponding to the plurality of specific information bits of the first reference signal may be determined as the first reception energy information. For example, the first specific information bit carried by the first reference signal is 11, and the second specific information bit carried by the first reference signal is 11, the maximum value of the energy values corresponding to the first specific information bit 11 and the second specific information bit 11 may be determined as the first reception energy information.

In yet another implementation, a minimum value of reception energies corresponding to the plurality of reference wireless resources may be determined as the first reception energy information.

In an implementation, a minimum value of accumulated energies of the reference wireless resources among the reception energies corresponding to the plurality of reference wireless resources may be determined as the first reception energy information. For example, the reference wireless resources include a first reference wireless resource, a second reference wireless resource, and a third reference wireless resource. If an accumulated energy of the first reference wireless resource is the minimum value, an accumulated energy value of the first reference wireless resource may be determined as the first reception energy information.

In another implementation manner, an average value of the reception energy corresponding to at least one reference wireless resource may be determined as the first reception energy information.

In another implementation, an average energy value of specific information corresponding to the plurality of time domain symbols of the first reference signal may be determined as the first reception energy information. For example, the specific information is 1, a first time domain symbol of the first reference signal carries information 1, and a second time domain symbol carries information 1, and an average energy value of the first time domain symbol and the second time domain symbol may be determined as the first reception energy information.

It should be noted that the first reception energy information may also be used to represent the reception energy information of the wake-up signal. For example, the first reception energy information may be used to represent a maximum reception energy of the wake-up signal. For another example, the first reception energy information may be used to represent a minimum reception energy of the wake-up signal. For another example, the first reception energy information may be used to represent an average reception energy of the wake-up signal. For another example, the first reception energy information may be used to represent a specific information bit energy of the wake-up signal.

In some embodiments, the terminal may determine a first candidate energy threshold parameter based on the first reception energy information; and determine the energy threshold parameter based on the first candidate energy threshold parameter.

For example, the first candidate energy threshold parameter may be determined as the energy threshold parameter.

For another example, the energy threshold parameter may be calculated based on the first candidate energy threshold parameter and a bias parameter.

The bias parameter may be a parameter predefined by the terminal, or a parameter sent by the network device to the terminal.

In an implementation, a sum of the first candidate energy threshold parameter and the bias parameter may be determined as the energy threshold parameter, and the bias parameter may be a positive number or a negative number, which is not limited in the present disclosure. For example, the bias parameter is i, and the first candidate capability threshold parameter includes a and b, then the energy threshold parameter may include a+i and b+i.

In another implementation, a product of the first candidate energy threshold parameter and the bias parameter may be determined as the energy threshold parameter, and the bias parameter may be a value greater than or equal to 1, or a value less than 1 and greater than 0, which is not limited in the present disclosure. For example, the bias parameter may also be referred to as a first coefficient, and a value of the first coefficient may be any value from 0.5 to 2. For example, the bias parameter is j, and the first candidate capability threshold parameter includes a and b, then the energy threshold parameter may include a*j and b*j.

In this way, the terminal may determine the first candidate energy threshold parameter based on the first reception energy information, and calculate the energy threshold parameter based on the first candidate energy threshold parameter and the bias parameter.

In another embodiment of the present disclosure, the first reference signal may include a second candidate energy threshold parameter; and the terminal may determine the energy threshold parameter based on the second candidate energy threshold parameter.

The first reference signal is different from the wake-up signal, and the first reference signal may also be referred to as a first reference message. The first reference signal may include at least one of a radio resource control (RRC) message, a media-access-control control element (MAC CE), downlink control information (DCI), or other messages sent by the network device to the terminal.

In an implementation, the second candidate energy threshold parameter may be determined as the energy threshold parameter.

In another implementation, the second candidate energy threshold parameter may be a threshold index. For example, N groups of third candidate energy threshold parameters may be predefined (e.g., predefined by a protocol, or predefined by the network device and the terminal). The threshold index may be used to indicate one group of the N groups of third candidate energy threshold parameters, and the third candidate energy threshold parameter corresponding to the threshold index is determined as the energy threshold parameter, where N may be any positive integer, such as 1, 2, or 4.

In this way, the terminal may determine the energy threshold parameter based on the second candidate energy threshold parameter in the first reference signal.

In some embodiments of the present disclosure, the terminal may acquire information carried by the wake-up signal based on second reception energy information of the wake-up signal and the energy threshold parameter.

The second reception energy information may include a second reception energy value corresponding to wireless resources on which the terminal receives the wake-up signal. The second reception energy value may be a maximum value, a minimum value or an average value of reception energies corresponding to the wireless resources. A unit of the second reception energy value may be decibel milliwatt (dBm) or milliwatt (mw). There may be one or more energy threshold parameters, and different energy threshold parameters may be set based on the modulation mode of the wake-up signal. Similarly, the second reception energy value may also be referred to as a second reception power or a second reception energy amplitude, and the second reception energy value may be an energy or a power of the terminal receiving the wake-up signal.

In some embodiments, the wake-up signal may include a data signal and/or a synchronization signal. The data signal may be used to carry data information, the synchronization signal may be used to carry synchronization information, and the information carried by the wake-up signal may include the data information and/or the synchronization information. It should be noted that the data signal may also be referred to as a data portion of the wake-up signal, and the synchronization signal may also be referred to as a synchronization portion of the wake-up signal.

In an implementation, in response to the modulation mode of the wake-up signal being an MC-OOK modulation mode, there may be one energy threshold parameter. In a case where the second reception energy value is less than the energy threshold parameter, it may be determined that the information carried by the wake-up signal is a first bit value (e.g., 0). In a case where the second reception energy value is greater than or equal to the energy threshold parameter, it may be determined that the information carried by the wake-up signal is a second bit value (e.g., 1).

In another implementation, in response to the modulation mode of the wake-up signal being the MC-OOK modulation mode, there may be two energy threshold parameters, for example, the energy threshold parameters may include a first threshold and a second threshold, and the first threshold may be less than the second threshold. In a case where the second reception energy value is less than or equal to the first threshold, it may be determined that the information carried by the wake-up signal is a first bit value (e.g., 0). In a case where the second reception energy value is greater than or equal to the second threshold, it may be determined that the information carried by the wake-up signal is a second bit value (e.g., 1).

In another implementation, in response to the modulation mode of the wake-up signal being an ASK modulation mode, there may also be a plurality of energy threshold parameters, for example, the energy threshold parameters may include a third threshold, a fourth threshold and a fifth threshold, and the third threshold may be greater than the fourth threshold, and the fourth threshold may be greater than the fifth threshold. In a case where the second reception energy value is less than or equal to the third threshold, it may be determined that the information carried by the wake-up signal is a third bit value (e.g., 00). In a case where the second reception energy value is greater than the third threshold and less than or equal to the fourth threshold, it may be determined that the information carried by the wake-up signal is a fourth bit value (e.g., 01). In a case where the second reception energy value is greater than the fourth threshold and less than or equal to the fifth threshold, it may be determined that the information carried by the wake-up signal is a fifth bit value (e.g., 10). In a case where the second reception energy value is greater than the fifth threshold, it may be determined that the information carried by the wake-up signal is a sixth bit value (e.g., 11).

In some embodiments, the wireless resource corresponding to the wake-up signal may include at least one time domain resource, each time domain resource may include at least one symbol, at least one slot, at least one sub-frame or at least one frame. The above second reception energy information may include the second reception energy value corresponding to each time domain resource of the wake-up signal.

For example, the wake-up signal may include 14 time domain resources, each time domain resource includes one time domain symbol, and the second reception energy information may include a second reception energy value of each time domain symbol (that is, a total of 14 reception energy values). For another example, the wake-up signal may include 7 time domain resources, each time domain resource may include two time domain symbols, and the second reception energy information may include a second reception energy value of each time domain resource (that is, a total of 7 reception energy values. For another example, the wake-up signal may include 2 time domain resources, each time domain resource may include 7 time domain symbols, and the second reception energy information may include the second reception energy value of each time domain resource (that is, a total of 2 reception energy values).

In some embodiments, the wireless resource corresponding to the wake-up signal may include at least one frequency domain resource, each frequency domain resource may include at least one frequency domain element (RE), at least one resource block (RB), or at least one resource block group (RBG). The above second reception energy information may include the second reception energy value corresponding to each frequency domain resource of the wake-up signal.

For example, the wake-up signal may include 12 frequency domain resources, each frequency domain resource includes one resource block, and the second reception energy information may include a second reception energy value of each resource block (that is, a total of 12 reception energy values).

In some embodiments, the wireless resource corresponding to the wake-up signal may include at least one time-frequency domain resource block, each time-frequency resource block corresponds to the above at least one time domain resource in the time domain, and corresponds to the above at least one frequency domain resource in the frequency domain. The above second reception energy information may include a second reception energy value corresponding to each time-frequency domain resource block of the wake-up signal.

For example, the wake-up signal may include 4 time-frequency domain resource blocks, each time-frequency domain resource block includes one resource block, and the second reception energy information may include the second reception energy value of each resource block (that is, a total of 4 reception energy values).

The terminal may determine bit information corresponding to each wireless resource based on the above energy threshold parameter and the second reception energy value corresponding to each wireless resource of the wake-up signal.

In this way, the information carried by the wake-up signal may be acquired based on the second reception energy information of the wake-up signal and the energy threshold parameter.

By means of the above method, the terminal may acquire the first reference signal and determine the energy threshold parameter corresponding to the wake-up signal based on the first reference signal. In this way, the energy threshold parameter may be flexibly determined, an accuracy of acquiring the information carried by the wake-up signal based on the energy threshold parameter may be improved.

It should be noted that there may be a plurality of manners for the terminal to determine the energy threshold parameter of the wake-up signal based on the first reception energy information, examples of which are as follows.

In some embodiments of the present disclosure, there may be one first reception energy information, and the terminal may determine one or more energy threshold parameters based on the first reception energy information.

The first reception energy information may include a first reception energy value corresponding to a reference wireless resource on which the terminal receives the first reference signal. The first reception energy value may be a maximum value, a minimum value or an average value of the reception energy corresponding to the reference wireless resource. A unit of the first reception energy value may be decibel milliwatt (dBm) or milliwatt (mw).

In some embodiments, the terminal may determine the first reception energy as the energy threshold parameter.

In another embodiment, the terminal may calculate the energy threshold parameter based on the first reception energy information and a first energy coefficient. For example, a product of the first reception energy value and the first energy coefficient may be determined as the energy threshold parameter.

There may be one or more first energy coefficients.

In an implementation, there may be one first energy coefficient. The first energy coefficient may be any value greater than 0, for example, the first energy coefficient may be 0.5, 1 or 2.

In another implementation, there may be a plurality of first energy coefficients. For example, the first energy coefficients may be a first coefficient group, and the first coefficient group may include M first energy coefficients. M may be any positive integer greater than 1, for example, M may be 2, 3, 6 or 7.

For example, M may be 2, and the first energy coefficients in the first coefficient group may be ⅔ and ⅓, respectively. Or, the first energy coefficients in the first coefficient group may be 0.42857 and 0.14286, respectively. Or, the first energy coefficients in the first coefficient group may be ¾ and ½, respectively. Or, the first energy coefficients in the first coefficient group may be ½ and ¼, respectively.

For another example, M may be 3, and the first energy coefficients in the first coefficient group may be 1, ⅔, and ⅓, respectively. Or, the first energy coefficients in the first coefficient group may be. Or, the first energy coefficients in the first coefficient group may be 1, 0.42857, and 0.14286, respectively. Or, the first energy coefficients in the first coefficient group may be 1, ¾, and ½, respectively. Or, the first energy coefficients in the first coefficient group may be 1, ½, and ¼, respectively.

For another example, M may be 6, and the first energy coefficients in the first coefficient group may be 6/7, 5/7, 4/7, 3/7, 2/7, and 1/7, respectively.

For another example, M may be 7, and the first energy coefficients in the first coefficient group may be 1, 6/7, 5/7, 4/7, 3/7, 2/7, and 1/7, respectively.

In this way, the terminal may calculate one or more energy threshold parameters based on the first energy coefficient and the first reception energy.

There may be a plurality of manners for determining the first energy coefficient, examples of which are as follows.

In some embodiments, the first energy coefficient may be a coefficient predefined by a protocol. The terminal may determine a coefficient predefined by a protocol as the first energy coefficient.

In another embodiment, the first energy coefficient may be a coefficient received from the network device. For example, the network device may predetermine the first energy coefficient and send the first energy coefficient to the terminal via any one of an RRC message, a MAC CE or a DCI. The terminal may receive the first energy coefficient from the network device.

In another embodiment, the first energy coefficient may be a coefficient that is predefined by the terminal and sent to the network device. For example, the terminal may predetermine the first energy coefficient and send the first energy coefficient to the network device via the RRC message or the MAC CE.

In yet another embodiment, the first energy coefficient may be a coefficient determined based on a modulation mode of the wake-up signal, and the modulation mode may include a multi-carrier on-off keying (MC-OOK) modulation mode or an amplitude shift keying (ASK) modulation mode.

For example, in a case that the modulation mode is the MC-OOK modulation mode, there may be one first energy coefficient. In this way, the terminal may calculate one energy threshold parameter based on the first reception energy information and the first energy coefficient. In a case where the second reception energy value of the wake-up signal received by the terminal is less than the energy threshold parameter, it may be determined that the information carried by the wake-up signal is a first bit value (e.g., 0). In a case where the second reception energy value is greater than or equal to the energy threshold parameter, it may be determined that the information carried by the wake-up signal is a second bit value (e.g., 1).

For another example, in a case where the modulation mode is the MC-OOK modulation mode, there may be two first energy coefficients. In this way, the terminal may calculate two energy threshold parameters based on the first reception energy information and the first energy coefficients. For example, the calculated energy threshold parameters may include a first threshold and a second threshold, and the first threshold may be less than the second threshold. In a case where the second reception energy value of the wake-up signal received by the terminal is less than or equal to the first threshold, it may be determined that the information carried by the wake-up signal is a first bit value (e.g., 0). In a case where the second reception energy value is greater than or equal to the second threshold, it may be determined that the information carried by the wake-up signal is a second bit value (e.g., 1).

For another example, in a case where the modulation mode is the ASK modulation mode, there may be a plurality of first energy coefficients, for example, N first energy coefficients. N may be 3 or 7. In this way, the terminal may calculate N energy threshold parameters based on the first reception energy information and the N first energy coefficients. For example, taking N equal to 3 as an example, the calculated energy threshold parameters may include a third threshold, a fourth threshold, and a fifth threshold, and the third threshold may be greater than the fourth threshold, and the fourth threshold may be greater than the fifth threshold. In a case where the second reception energy value of the wake-up signal received by the terminal is less than or equal to the third threshold, it may be determined that the information carried by the wake-up signal is a third bit value (e.g., 00). In a case where the second reception energy value is greater than the third threshold and less than or equal to the fourth threshold, it may be determined that the information carried by the wake-up signal is a fourth bit value (e.g., 01). In a case where the second reception energy value is greater than the fourth threshold and less than or equal to the fifth threshold, it may be determined that the information carried by the wake-up signal is a fifth bit value (e.g., 10). In a case where the second reception energy value is greater than the fifth threshold, it may be determined that the information carried by the wake-up signal is a sixth bit value (e.g., 11).

In this way, the terminal may determine the first energy coefficient based on any of the above methods, determine the energy threshold parameter based on the first energy coefficient and the first reception energy information of the first reference signal, and determine the information carried by the wake-up signal based on the energy threshold parameter.

In some embodiments, the first reference signal may be a signal different from the wake-up signal.

In another embodiment, the first reference signal may be a part of the wake-up signal, for example, the first reference signal may be a reference portion of the wake-up signal. The wake-up signal may include a data portion and/or a synchronization portion. The reference portion may be used to carry the first reference signal, the data portion may be used to carry data information, the synchronization portion may be used to carry synchronization information, and the terminal may synchronize with the network device based on the synchronization information. The data information and/or the synchronization information may be information carried by the wake-up signal.

In another embodiment of the present disclosure, there may be a plurality of first reception energy information, and the first reference signal may be a signal received via a plurality of reference wireless resources, and each reference wireless resource corresponds to different first reception energy information. In this way, the terminal may acquire the first reception energy information corresponding to the reference wireless resource, and determine the energy threshold parameter based on the first reception energy information.

For example, there may be a plurality of reference wireless resources for the terminal to receive the first reference signal, that is, the terminal receives the first reference signal via the plurality of reference wireless resources. Each reference wireless resource may include at least one symbol, at least one slot, at least one sub-frame or at least one frame. The above first reception energy information may include a first reception energy value corresponding to each reference wireless resource of the first reference signal. Similarly, the first reception energy value may be a maximum value, a minimum value or an average value of reception energies corresponding to reference wireless resources. A unit of the first reception energy value may be decibel milliwatt (dBm) or milliwatt (mw). The first reception energy value may be referred to as a first reception power or a first reception energy amplitude. The first reception energy value may be an energy or a power of the first reference signal received by the terminal.

It should be noted that the reference wireless resource may be a time domain resource, a frequency domain resource or a time-frequency resource.

In some embodiments, the reference wireless resource may correspond to one first bit information, and the terminal may acquire the first reception energy information and the first bit information corresponding to the reference wireless resource, and determine the energy threshold parameter based on the first reception energy information and the first bit information.

For example, the first reference signal may be a signal received by the terminal via N reference wireless resources, each reference wireless resource corresponds to the first bit information and the first reception energy value. N may be any positive integer greater than or equal to 1.

For example, N is 3, and the first reference signal may be a signal received by the terminal via a first reference wireless resource, a second reference wireless resource, and a third reference wireless resource, and first bit information corresponding to the first reference wireless resource is 11, and the first reception energy value of the first reference wireless resource is a. The first bit information corresponding to the second reference wireless resource is 10, and the first reception energy value of the second reference wireless resource is b. The first bit information corresponding to the third reference wireless resource is 01, and the first reception energy value of the third reference wireless resource is c. Thus, the energy threshold parameters may include a, b, and c. In a case of receiving the wake-up signal, the terminal may determine the information carried by the wake-up signal based on the second reception energy value of the wake-up signal. For example, in response to the second reception energy value of the wake-up signal being greater than or equal to a, the information carried by the wake-up signal may be 11. In response to the second reception energy value of the wake-up signal being less than a and greater than or equal to b, the information carried by the wake-up signal may be 10. In response to the second reception energy value of the wake-up signal being less than b and greater than or equal to c, the information carried by the wake-up signal may be 01. In response to the second reception energy value of the wake-up signal being less than c, the information carried by the wake-up signal may be 11.

In some embodiments, the number of reference wireless resources for receiving the first reference signal is a number predefined by a protocol. The number may be any positive integer, for example, the number may be 1, 2, 3 , 7 or 15.

In another embodiment, the number of reference wireless resources for receiving the first reference signal is a number determined based on a modulation mode of the wake-up signal, and the modulation mode includes a multi-carrier on-off keying (MC-OOK) modulation mode or an amplitude shift keying (ASK) modulation mode.

For example, in response to the modulation mode of the wake-up signal being the MC-OOK modulation mode, the number of reference wireless resources for receiving the first reference signal may be 1 or 2.

For another example, in response to the modulation mode of the wake-up signal being the MC-OOK modulation mode, the number of reference wireless resources for receiving the first reference signal may be 1 or 2.

For example, in a case where the modulation mode is the MC-OOK modulation mode, the number of reference wireless resources for receiving the first reference signal may be 1. In this way, the terminal may determine one energy threshold parameter based on the first reception energy information of the reference wireless resource. In a case where the second reception energy value of the wake-up signal received by the terminal is less than the energy threshold parameter, it may be determined that the information carried by the wake-up signal is a first bit value (e.g., 0). In a case where the second reception energy value is greater than or equal to the energy threshold parameter, it may be determined that the information carried by the wake-up signal is a second bit value (e.g., 1).

For another example, in a case where the modulation mode is the MC-OOK modulation mode, the number of reference wireless resources for receiving the first reference signal may be two. In this way, the terminal may determine two energy threshold parameters based on the first reception energy information of the two reference wireless resources. For example, the energy threshold parameters may include a first threshold and a second threshold, and the first threshold may be less than the second threshold. In a case where the second reception energy value of the wake-up signal received by the terminal is less than or equal to the first threshold, it may be determined that the information carried by the wake-up signal is a first bit value (e.g., 0). In a case where the second reception energy value is greater than or equal to the second threshold, it may be determined that the information carried by the wake-up signal is a second bit value (e.g., 1).

For another example, in a case where the modulation mode is the ASK modulation mode, the number of reference wireless resources for receiving the first reference signal may be more than one, for example, may be N, where N may be 3 or 7. In this way, the terminal may determine N energy threshold parameters based on the first reception energy information of the N reference wireless resources. For example, taking N equal to 3 as an example, the energy threshold parameters may include a third threshold, a fourth threshold, and a fifth threshold, and the third threshold may be greater than the fourth threshold, and the fourth threshold may be greater than the fifth threshold. In a case where the second reception energy value of the wake-up signal received by the terminal is less than or equal to the third threshold, it may be determined that the information carried by the wake-up signal is a third bit value (e.g., 00). In a case where the second reception energy value is greater than the third threshold and less than or equal to the fourth threshold, it may be determined that the information carried by the wake-up signal is a fourth bit value (e.g., 01). In a case where the second reception energy value is greater than the fourth threshold and less than or equal to the fifth threshold, it may be determined that the information carried by the wake-up signal is a fifth bit value (e.g., 10). In a case where the second reception energy value is greater than the fifth threshold, it may be determined that the information carried by the wake-up signal is a sixth bit value (e.g., 11).

In this way, the terminal may determine at least one energy threshold parameter based on the first reception energy information corresponding to the reference wireless resource of the first reference signal by means of any one of the above methods, and determine the information carried by the wake-up signal based on the energy threshold parameter.

In some embodiments, the first reference signal may be a signal different from the wake-up signal.

In another embodiment, the first reference signal may be a part of the wake-up signal, for example, the first reference signal may be a reference portion in the wake-up signal. The wake-up signal may include a data portion and/or a synchronization portion. The reference portion may be used to carry the first reference signal, the data portion may be used to carry data information, the synchronization portion may be used to carry synchronization information, and the terminal may synchronize with the network device based on the synchronization information. The data information and/or the synchronization information may be the information carried by the wake-up signal.

In another embodiment, the first reference signal may be the synchronization portion in the wake-up signal, the synchronization portion may include a synchronization bit sequence, and the first bit information may be information in the synchronization bit sequence. For example, the first bit information may be a subset of the synchronization bit sequence. The wake-up signal may also include a data portion, the data portion may be used to carry data information, and the data information may be the information carried by the wake-up signal.

For example, the synchronization bit sequence may be any predetermined bit sequence, and a length of the synchronization bit sequence may be any predetermined value, such as 16 bits, 32 bits, 64 bits, 128 bits or 256 bits. For example, the synchronization bit sequence may be the following 32-bit bit sequence: [10100100101110110001011100111000].

In an implementation, the synchronization bit sequence may be split into a plurality of first bit information, for example, 11, 10 and 01 may be split from the synchronization bit sequence as the first bit information, and the reception energy of the reference wireless resource for sending the first bit information may be determined as the first reception energy. In this way, the energy threshold parameter may be determined based on the first reception energy information and the first bit information.

Regarding a specific method of determining the energy threshold parameter based on the first reception energy information and the first bit information, reference can be made to description in the aforementioned embodiments of the present disclosure, and details are not repeated herein.

In this way, the terminal may determine the energy threshold parameter based on the synchronization portion of the wake-up signal, and acquire the information carried by the wake-up signal based on the energy threshold parameter.

FIG. 3 is a flow chart illustrating a method for information determination based on an illustrative embodiment. As shown in FIG. 3, the method may include the following steps.

At step S301, a terminal receives a first reference signal sent by a network device.

At step S302, the terminal receives a wake-up signal sent by the network device.

At step S303, the terminal determines an energy threshold parameter corresponding to the wake-up signal based on the first reference signal.

For example, the terminal may acquire first reception energy information of the first reference signal, and determine the energy threshold parameter of the wake-up signal based on the first reception energy information.

The first reference signal is different from the wake-up signal, a first time domain position of the first reference signal is located before a second time domain position of the wake-up signal, and a time interval between the first time domain position and the second time domain position is greater than or equal to a first time interval.

The first time domain position may be a first symbol of the first reference signal or a last symbol of the first reference signal. For example, the first time domain position may be a position of a first time domain symbol of the first reference signal received by the terminal, or the first time domain position may be a position of a last time domain symbol of the first reference signal received by the terminal.

Similarly, the second time domain position may be a first symbol of the wake-up signal or a last symbol of the wake-up signal. For example, the second time domain position may be a position of a first time domain symbol of the wake-up signal received by the terminal, or the second time domain position may be a position of a last time domain symbol of the wake-up signal received by the terminal.

In some embodiments, the first time interval may be L time units, and the time unit may be a symbol, a slot, a subframe, a radio frame, or a millisecond. For example, the first time interval may be any one of L1 symbols, L2 slots, L3 subframes, LA radio frames or L5 milliseconds, where L1 may be any integer greater than or equal to 0, and similarly, L2, L3, L4 and L5 may also be any integer greater than or equal to 0.

In some embodiments, the first time interval may be a time interval predefined by a protocol.

In another embodiment, the first time interval may be a time interval that is pre-set by the terminal and sent to the network device.

The network device may include an access network device and/or a core network device.

In an implementation, in response to the network device being the core network device, the terminal may send the first time interval to the core network device via a registration request message or a position update message, and the core network device may send the first time interval to the access network device.

In another embodiment, the first time interval may be a time interval that is pre-set by the network device and sent to the terminal.

In some embodiments, the first time interval may be any one of:
the number of time domain symbols between a first symbol of the first reference signal and a first symbol of the wake-up signal;
the number of time domain symbols between a first symbol of the first reference signal and a last symbol of the wake-up signal;
a time interval between a last symbol of the first reference signal and a first symbol of the wake-up signal;
the number of time domain symbols between a last symbol of the first reference signal and a last symbol of the wake-up signal;
the number of slots between a slot where a first symbol of the first reference signal is located and a slot where a first symbol of the wake-up signal is located;
the number of slots between a slot where a first symbol of the first reference signal is located and a slot where a last symbol of the wake-up signal is located;
the number of slots between a slot where a last symbol of the first reference signal is located and a slot where a first symbol of the wake-up signal is located; or
the number of slots between a slot where a last symbol of the first reference signal is located and a slot where a last symbol of the wake-up signal is located.

The first symbol of the first reference signal may be the first time domain symbol of the first reference signal received by the terminal, and the last symbol of the first reference signal may be the last time domain symbol of the first reference signal received by the terminal. Similarly, the first symbol of the wake-up signal may be the first time domain symbol of the wake-up signal received by the terminal, and the last symbol of the wake-up signal may be the last time domain symbol of the wake-up signal received by the terminal.

It should be noted that, without contradiction, the present embodiment may be combined with the preceding embodiments or implementations of the present disclosure and its various optional solutions, and the specific implementation of the above steps in the present embodiment may also refer to the description in the preceding embodiments of the present disclosure, which is not repeated herein. For example, for a specific implementation of the terminal determining the energy threshold parameter corresponding to the wake-up signal based on the first reference signal in the above step S303 in this embodiment, reference can be made to description of the embodiment shown in FIG. 2 of the present disclosure.

In this way, the terminal may determine the energy threshold parameter based on the first reference signal, and acquire the information carried by the wake-up signal based on the energy threshold parameter.

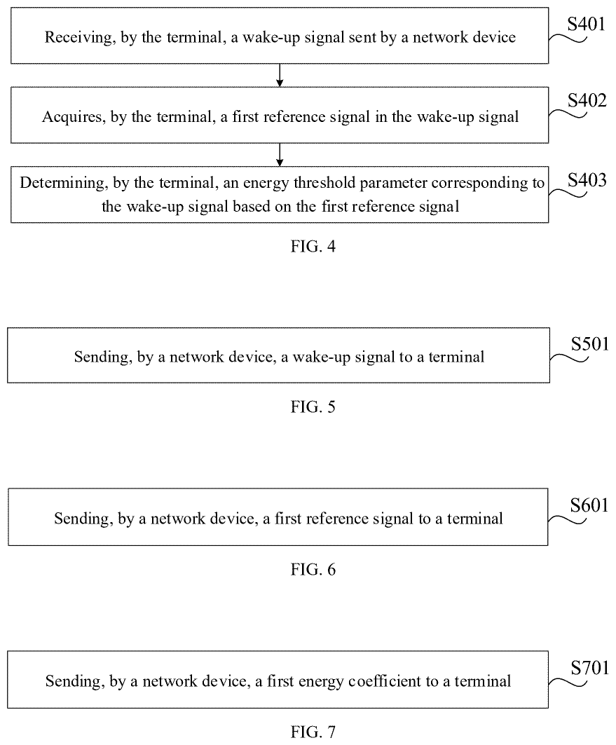

FIG. 4 is a flow chart illustrating a method for information determination based on an illustrative embodiment. As shown in FIG. 4, the method may include the following steps.

At step S401, the terminal receives a wake-up signal sent by a network device.

The wake-up signal may include a first reference signal and other signals, a third time domain position of the first reference signal is located before a fourth time domain position of the other signals, and a time interval between the third time domain position and the fourth time domain position may be greater than or equal to a second time interval.

In some embodiments, other signals of the wake-up signal may be data signals and/or synchronization signals, and the data signal may be used to carry data information, the synchronization signal may be used to carry synchronization information, and the information carried by the wake-up signal may include the data information and/or the synchronization information.

The third time domain position may be a first symbol of the first reference signal or a last symbol of the first reference signal. For example, the third time domain position may be a position of a first time domain symbol of the first reference signal received by the terminal, or the third time domain position may be a position of a last time domain symbol of the first reference signal received by the terminal.

Similarly, the fourth time domain position may be a first symbol of the other signals or a last symbol of the other signals. For example, the fourth time domain position may be a position of a first time domain symbol of the other signals received by the terminal, or the fourth time domain position may be a position of a last time domain symbol of the other signals received by the terminal.

Similarly, the second time interval may be L time units, and the time unit may be a symbol, a slot, a subframe, a radio frame, or a millisecond. For example, the second time interval may be any one of L1 symbols, L2 slots, L3 subframes, L4 radio frames, or L5 milliseconds, where L1 may be any integer greater than or equal to 0, and similarly, L2, L3, L4, and L5 may also be any integer greater than or equal to 0.

In some embodiments, the second time interval may be a time interval predefined by a protocol.

In another embodiment, the second time interval may be a time interval that is pre-set by the terminal and sent to the network device.

The network device may include an access network device and/or a core network device.

In another embodiment, the second time interval may be a time interval that is pre-set by the network device and sent to the terminal.

In some embodiments, the second time interval may be any one of:
the number of time domain symbols between a first symbol of the first reference signal and a first symbol of the other signals;
the number of time domain symbols between a first symbol of the first reference signal and a last symbol of the other signals;
a time interval between a last symbol of the first reference signal and a first symbol of the other signals;
the number of time domain symbols between a last symbol of the first reference signal and a last symbol of the other signals;
the number of slots between a slot where a first symbol of the first reference signal is located and a slot where a first symbol of the other signals is located;
the number of slots between a slot where a first symbol of the first reference signal is located and a slot where a last symbol of the other signals is located;
the number of slots between a slot where a last symbol of the first reference signal is located and a slot where a first symbol of the other signals is located; or
the number of slots between a slot where a last symbol of the first reference signal is located and a slot where a last symbol of the other signals is located.

The first symbol of the first reference signal may be the first time domain symbol of the first reference signal received by the terminal, and the last symbol of the first reference signal may be the last time domain symbol of the first reference signal received by the terminal. Similarly, the first symbol of the other signals may be the first time domain symbol of the other signals received by the terminal, and the last symbol of the other signals may be the last time domain symbol of the other signals received by the terminal.

At step S402, the terminal acquires a first reference signal in the wake-up signal.

At step S403, the terminal determines an energy threshold parameter corresponding to the wake-up signal based on the first reference signal.

For example, the terminal may obtain first reception energy information of the first reference signal, and determine the energy threshold parameter of the wake-up signal based on the first reception energy information.

It should be noted that, without contradiction, the present embodiment may be combined with the preceding embodiments or implementations of the present disclosure and its various optional solutions, and the specific implementation of the above steps in the present embodiment may also refer to the description in the preceding embodiments of the present disclosure, which is not repeated herein. For example, for a specific implementation of the terminal determining the energy threshold parameter corresponding to the wake-up signal based on the first reference signal in the above step S403 in this embodiment, reference can also be made to description of the embodiment shown in FIG. 2 of the present disclosure.

In this way, the terminal may determine the energy threshold parameter based on the first reference signal in the wake-up signal, and acquire the information carried by the wake-up signal based on the energy threshold parameter.

FIG. 5 is a flow chart illustrating a method for information determination based on an illustrative embodiment. The method may be performed by a network device in the above communication system. As shown in FIG. 5, the method may include the following steps.

At step S501, the network device sends a wake-up signal to a terminal.

In some embodiments, the wake-up signal may be used to indicate the terminal to determine an energy threshold parameter corresponding to the wake-up signal based on the first reference signal, and the energy threshold parameter is used to determine information carried by the wake-up signal.

In some embodiments, the wake-up signal may be used to indicate the terminal to change a sleep state.

In some embodiments, the first reference signal may be a signal different from the wake-up signal.

In another embodiment, the first reference signal may be a part of the wake-up signal, for example, the first reference signal may be a reference portion of the wake-up signal. The wake-up signal may include a data portion and/or a synchronization portion. The reference portion may be used to carry the first reference signal, the data portion may be used to carry data information, the synchronization portion may be used to carry synchronization information, and the terminal may synchronize with the network device based on the synchronization information. The data information and/or the synchronization information may be information carried by the wake-up signal.

In some embodiments, the first reference signal may be a signal received sent by a network device via at least one reference wireless resource, and the number of reference wireless resources may be a number predefined by the protocol; or, the number of reference wireless resources may be a number determined based on a modulation mode of the wake-up signal, the modulation mode may include a multi-carrier on-off keying (MC-OOK) modulation mode or an amplitude shift keying (ASK) modulation mode.

In some embodiments, the wake-up signal may include the first reference signal and other signals, a third time domain position of the first reference signal is located before a fourth time domain position of the other signals, and a time interval between the third time domain position and the fourth time domain position is greater than or equal to a second time interval.

The third time domain position may be a first symbol of the first reference signal or a last symbol of the first reference signal. For example, the third time domain position may be a position of a first time domain symbol of the first reference signal received by the terminal, or the third time domain position may be a position of a last time domain symbol of the first reference signal received by the terminal.

Similarly, the fourth time domain position may be a first symbol of the other signals or a last symbol of the other signals. For example, the fourth time domain position may be a position of a first time domain symbol of the other signals received by the terminal, or the fourth time domain position may be a position of a last time domain symbol of the other signals received by the terminal.

In some embodiments, the second time interval may be L time units, and the time unit may be a symbol, a slot, a subframe, a radio frame, or a millisecond. For example, the second time interval may be any one of L1 symbols, L2 slots, L3 subframes, LA radio frames, or L5 milliseconds, where L1 may be any integer greater than or equal to 0, and similarly, L2, L3, L4, and L5 may also be any integer greater than or equal to 0.

In some embodiments, the second time interval may be a time interval predefined by a protocol.

In another embodiment, the second time interval may be a time interval that is pre-set by the terminal and sent to the network device.

In another embodiment, the second time interval may be a time interval that is pre-set by the network device and sent to the terminal.

In some embodiments, the second time interval may be any one of:
the number of time domain symbols between a first symbol of the first reference signal and a first symbol of the other signals;
the number of time domain symbols between a first symbol of the first reference signal and a last symbol of the other signals;
a time interval between a last symbol of the first reference signal and a first symbol of the other signals;
the number of time domain symbols between a last symbol of the first reference signal and a last symbol of the other signals;
the number of slots between a slot where a first symbol of the first reference signal is located and a slot where a first symbol of the other signals is located;
the number of slots between a slot where a first symbol of the first reference signal is located and a slot where a last symbol of the other signals is located;
the number of slots between a slot where a last symbol of the first reference signal is located and a slot where a first symbol of the other signals is located; or
the number of slots between a slot where a last symbol of the first reference signal is located and a slot where a last symbol of the other signals is located.

The first symbol of the first reference signal may be the first time domain symbol of the first reference signal received by the terminal, and the last symbol of the first reference signal may be the last time domain symbol of the first reference signal received by the terminal. Similarly, the first symbol of the other signals may be the first time domain symbol of the other signals received by the terminal, and the last symbol of the other signals may be the last time domain symbol of the other signals received by the terminal.

In some embodiments, other signals of the wake-up signal may be data signals and/or synchronization signals, and the data signal may be used to carry data information, the synchronization signal may be used to carry synchronization information, and the information carried by the wake-up signal may include the data information and/or the synchronization information.

In some embodiments, the first reference signal may be a reference portion in the wake-up signal.

In some embodiments, a sending energy of the first reference signal is a predetermined reference energy.

Similarly, the reference energy may also be referred to as a reference power or a reference energy amplitude. The reference energy may be an energy or a power used by the network device to send the first reference signal.

For example, the network device may send the first reference signal based on the reference energy, and there may be one or more reference energies.

The first reference signal may be a signal sent by the network device via at least one reference wireless resource, and the reference wireless resource may include a time domain resource, a frequency domain resource, or a time-frequency resource. The reference energy corresponding to each reference wireless resource may be the same or different.

For example, the network device may also send the first reference signal via one reference wireless resource.

For another example, the network device may also send the first reference signal via a plurality of reference wireless resources.

In some embodiments, the at least one reference wireless resource may be determined by the network device and sent to the terminal.

For example, the network device may determine the at least one reference wireless resource for sending the first reference signal, and determine a reference resource indication parameter based on the at least one reference wireless resource. The network device may also send the reference resource indication parameter to the terminal.

In another embodiment, the at least one reference wireless resource may be predefined by a protocol.

For example, the network device may send the first reference signal based on the at least one reference wireless resource predefined in the protocol; the terminal may also receive the first reference signal based on at least one reference wireless resource predefined in the protocol.

In another embodiments, each reference wireless resource may include at least one symbol. In response to each reference wireless resource including one symbol, the reference energy may be used to indicate a sending energy of the symbol. In response to each reference wireless resource including a plurality of symbols, the reference energy may be used to indicate a sum value or an average value of sending energies of the plurality of symbols.

In another embodiments, each reference wireless resource may include at least one resource element. In response to each reference wireless resource including one resource element, the reference energy may be used to indicate a sending energy of the resource element. In response to each reference wireless resource including a plurality of resource elements, the reference energy may be used to indicate a sum value or an average value of sending energies of the plurality of resource elements.

In another embodiments, each reference wireless resource may include at least one resource block. In response to each reference wireless resource including one resource block, the reference energy may be used to indicate a sending energy of the resource block. In response to each reference wireless resource including a plurality of resource blocks, the reference energy may be used to indicate a sum value or an average value of sending energies of the plurality of resource blocks.

It should be noted that, without contradiction, the present embodiment may be combined with the preceding embodiments or implementations of the present disclosure and its various optional solutions, and the specific implementation of the above steps in the present embodiment may also refer to the description in the preceding embodiments of the present disclosure, which is not repeated herein. For example, for a specific implementation of the terminal determining the energy threshold parameter corresponding to the wake-up signal based on the first reference signal, reference can also be made to description of the embodiment shown in FIG. 2 of the present disclosure.

By means of the above method, the network device may indicate the terminal to determine the energy threshold parameter corresponding to the wake-up signal based on the first reference signal. In this way, the energy threshold parameter may be flexibly determined, and an accuracy of the information carried in the wake-up signal acquired by the terminal based on the energy threshold parameter may be improved.

FIG. 6 is a flow chart illustrating a method for information determination according to an illustrative embodiment. As shown in FIG. 6, the method may include the following steps.

At step S601, a network device sends a first reference signal to a terminal.

The first reference signal is different from the wake-up signal, a first time domain position of the first reference signal is located before a second time domain position of the wake-up signal, and a time interval between the first time domain position and the second time domain position is greater than or equal to a first time interval.

The first time domain position may be a first symbol of the first reference signal or a last symbol of the first reference signal. For example, the first time domain position may be a position of a first time domain symbol of the first reference signal received by the terminal, or the first time domain position may be a position of a last time domain symbol of the first reference signal received by the terminal.

Similarly, the second time domain position may be a first symbol of the wake-up signal or a last symbol of the wake-up signal. For example, the second time domain position may be a position of a first time domain symbol of the wake-up signal received by the terminal, or the second time domain position may be a position of a last time domain symbol of the wake-up signal received by the terminal.

In some embodiments, the first time interval may be L time units, and the time unit may be a symbol, a slot, a subframe, a radio frame, or a millisecond. For example, the first time interval may be any one of L1 symbols, L2 slots, L3 subframes, L4 radio frames or L5 milliseconds, where L1 may be any integer greater than or equal to 0, and similarly, L2, L3, L4 and L5 may also be any integer greater than or equal to 0.

In some embodiments, the first time interval may be a time interval predefined by a protocol.

In another embodiment, the first time interval may be a time interval that is pre-set by the terminal and sent to the network device.

In another embodiment, the first time interval may be a time interval that is pre-set by the network device and sent to the terminal.

In some embodiments, the first time interval may be any one of:
the number of time domain symbols between a first symbol of the first reference signal and a first symbol of the wake-up signal;
the number of time domain symbols between a first symbol of the first reference signal and a last symbol of the wake-up signal;
a time interval between a last symbol of the first reference signal and a first symbol of the wake-up signal;
the number of time domain symbols between a last symbol of the first reference signal and a last symbol of the wake-up signal;
the number of slots between a slot where a first symbol of the first reference signal is located and a slot where a first symbol of the wake-up signal is located;
the number of slots between a slot where a first symbol of the first reference signal is located and a slot where a last symbol of the wake-up signal is located;
the number of slots between a slot where a last symbol of the first reference signal is located and a slot where a first symbol of the wake-up signal is located; or
the number of slots between a slot where a last symbol of the first reference signal is located and a slot where a last symbol of the wake-up signal is located.

The first symbol of the first reference signal may be the first time domain symbol of the first reference signal received by the terminal, and the last symbol of the first reference signal may be the last time domain symbol of the first reference signal received by the terminal. Similarly, the first symbol of the wake-up signal may be the first time domain symbol of the wake-up signal received by the terminal, and the last symbol of the wake-up signal may be the last time domain symbol of the wake-up signal received by the terminal.

In some embodiments, the sending energy of the first reference signal is a predetermined reference energy.

It should be noted that, without contradiction, the present embodiment may be combined with the preceding embodiments or implementations of the present disclosure and its various optional solutions, and the specific implementation of the above steps in the present embodiment may also refer to the description in the preceding embodiments of the present disclosure, which is not repeated herein. For example, for a specific implementation of the terminal determining the energy threshold parameter corresponding to the wake-up signal based on the first reference signal in the above step S303 in this embodiment, reference can be made to description of the embodiment shown in FIG. 2 of the present disclosure.

In this way, the terminal may determine the energy threshold parameter based on the first reference signal, and acquire the information carried by the wake-up signal based on the energy threshold parameter.

In some embodiments of the present disclosure, the above first reference signal may include a second candidate energy threshold parameter, and the second candidate energy threshold parameter is used to indicate the terminal to determine the energy threshold parameter.

FIG. 7 is a flow chart illustrating a method for information determination according to an illustrative embodiment. As shown in FIG. 7, the method may include the following steps.

At step S701, a network device sends a first energy coefficient to a terminal.

The first energy coefficient may be used to indicate the terminal to calculate the energy threshold parameter based on the first energy coefficient and first reception energy information of the first reference signal.

There may be one or more first energy coefficients.

In some embodiments, the first energy coefficient may be a coefficient determined based on a modulation mode of the wake-up signal, and the modulation mode may include a multi-carrier on-off keying (MC-OOK) modulation mode or an amplitude shift keying (ASK) modulation mode.

In an implementation manner, in a case that the modulation mode is the MC-OOK modulation mode, there may be one or two first energy coefficients.

In another implementation, in a case where the modulation mode is the ASK modulation mode, there may be a plurality of first energy coefficients.

It should be noted that, for the specific description of the first energy coefficient, reference can be made to the description of the aforementioned embodiment in the present disclosure, which is not repeated herein.

It should be noted that, without contradiction, the present embodiment may be combined with the preceding embodiments or implementations of the present disclosure and its various optional solutions, and the specific implementation of the above steps in the present embodiment may also refer to the description in the preceding embodiments of the present disclosure, which is not repeated herein.

In this way, the network device sends the first energy coefficient to the terminal, indicating the terminal to determine the energy threshold parameter based on the first energy coefficient and the first reception energy information of the first reference signal.

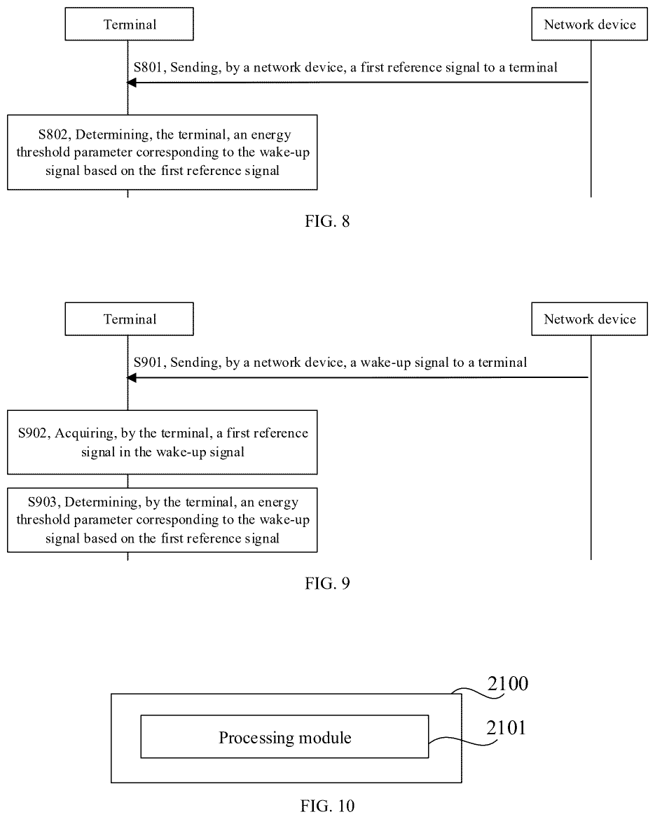

FIG. 8 is a flow chart illustrating a method for information determination according to an illustrative embodiment. As shown in FIG. 8, the method may include the following steps.

At step S801, a network device sends a first reference signal to a terminal.

At step S802, the terminal determines an energy threshold parameter corresponding to the wake-up signal based on the first reference signal.

It should be noted that, without contradiction, the present embodiment may be combined with the preceding embodiments or implementations of the present disclosure and its various optional solutions, and the specific implementation of the above steps in the present embodiment may also refer to the description in the preceding embodiments of the present disclosure, which is not repeated herein.

In some embodiments of the present disclosure, the network device may further send the wake-up signal to the terminal, and the terminal may further determine information carried by the wake-up signal based on the second reception energy information of the wake-up signal and the energy threshold parameter.

In this way, the terminal may determine the energy threshold parameter based on the first reference signal, and acquire the information carried by the wake-up signal based on the energy threshold parameter.

FIG. 9 is a flow chart illustrating a method for information determination according to an illustrative embodiment. As shown in FIG. 9, the method may include the following steps.

At step S901, a network device sends a wake-up signal to a terminal.

The wake-up signal may include a first reference signal and other signals.

At step S902, the terminal acquires a first reference signal in the wake-up signal.

At step S903, the terminal determines an energy threshold parameter corresponding to the wake-up signal based on the first reference signal.

It should be noted that, without contradiction, the present embodiment may be combined with the preceding embodiments or implementations of the present disclosure and its various optional solutions, and the specific implementation of the above steps in the present embodiment may also refer to the description in the preceding embodiments of the present disclosure, which is not repeated herein.

In some embodiments of the present disclosure, the terminal may also determine the information carried by the wake-up signal based on the second reception energy information of the wake-up signal and the energy threshold parameter.

In this way, the terminal may determine the energy threshold parameter based on the first reference signal in the wake-up signal, and acquire the information carried by the wake-up signal based on the energy threshold parameter.

In an illustrative embodiment, the present disclosure further provides a communication system, which may include a terminal and a network device. The terminal may perform the method for information determination involving the terminal in the aforementioned embodiment of the present disclosure. In addition, the network device may perform the method for information determination involving the network device in the aforementioned embodiment.

FIG. 10 is a block diagram illustrating an apparatus 2100 for information determination according to an illustrative embodiment. The apparatus may be configured in a terminal. As illustrated in FIG. 10, the apparatus 2100 may include:

a processing module 2101, configured to acquire a first reference signal, and determine an energy threshold parameter corresponding to a wake-up signal based on the first reference signal, in which, the wake-up signal is used to indicate the terminal to change a sleep state, and the energy threshold parameter is used to determine information carried by the wake-up signal.

In some embodiments, the processing module 2101 is configured to acquire first reception energy information of the first reference signal; and determine the energy threshold parameter based on the first reception energy information.

In some embodiments, the first reception energy information includes a maximum energy, a minimum energy, or an average energy of the first reference signal.

In some embodiments, the first reception energy information is one, and the processing module 2101 is configured to calculate the energy threshold parameter based on the first reception energy information and a first energy coefficient.

In some embodiments, the first energy coefficient is a coefficient predefined by a protocol; or
the first energy coefficient is a coefficient received from a network device; or
the first energy coefficient is a coefficient determined based on a modulation mode of the wake-up signal, in which the modulation mode includes a multi-carrier on-off keying (MC-OOK) modulation mode or an amplitude shift keying (ASK) modulation mode.

In some embodiments, in a case where the modulation mode is the MC-OOK modulation mode, the first energy coefficient is one. Or, in a case where the modulation mode is the ASK modulation mode, the first energy coefficient is more than one.

In some embodiments, the first reception energy information is more than one, and the first reference signal includes a plurality of time domain resources. The processing module 2101 is configured to acquire the first reception energy information and first bit information corresponding to the time domain resources; determine the energy threshold parameter based on the first reception energy information and the first bit information.

In some embodiments, the number of time domain resources included in the first reference signal is a number predefined by a protocol; or,
the number of time domain resources included in the first reference signal is a number determined based on a modulation mode of the wake-up signal, and the modulation mode includes a multi-carrier on-off keying (MC-OOK) modulation mode or an amplitude shift keying (ASK) modulation mode.

In some embodiments, the first reference signal is a synchronization portion in the wake-up signal, the synchronization portion includes a synchronization bit sequence, and the first bit information is information in the synchronization bit sequence.

In some embodiments, the processing module 2101 is configured to determine a first candidate energy threshold parameter based on the first reception energy information; and determine the first candidate energy threshold parameter as the energy threshold parameter, or calculate the energy threshold parameter based on the first candidate energy threshold parameter and a bias parameter.

In some embodiments, the processing module 2101 is configured to receive the first reference signal sent by a network device, in which the first reference signal is different from the wake-up signal, a first time domain position of the first reference signal is located before a second time domain position of the wake-up signal, and a time interval between the first time domain position and the second time domain position is greater than or equal to a first time interval.

In some embodiments, the first time interval is any one of:
a time interval predefined by a protocol;
a time interval that is pre-set by the terminal and sent to the network device; or
a time interval that is pre-set by the network device and sent to the terminal.

In some embodiments, the first time interval is any one of:
the number of time domain symbols between a first symbol of the first reference signal and a first symbol of the wake-up signal;
the number of time domain symbols between a first symbol of the first reference signal and a last symbol of the wake-up signal;
a time interval between a last symbol of the first reference signal and a first symbol of the wake-up signal;
the number of time domain symbols between a last symbol of the first reference signal and a last symbol of the wake-up signal;
the number of slots between a slot where a first symbol of the first reference signal is located and a slot where a first symbol of the wake-up signal is located;
the number of slots between a slot where a first symbol of the first reference signal is located and a slot where a last symbol of the wake-up signal is located;
the number of slots between a slot where a last symbol of the first reference signal is located and a slot where a first symbol of the wake-up signal is located; or
the number of slots between a slot where a last symbol of the first reference signal is located and a slot where a last symbol of the wake-up signal is located.

In some embodiments, the processing module 2101 is configured to receive the wake-up signal sent by a network device, in which, the wake-up signal comprises the first reference signal and other signals, a third time domain position of the first reference signal is located before a fourth time domain position of the other signals, and a time interval between the third time domain position and the fourth time domain position is greater than or equal to a second time interval; and acquire the first reference signal based on the wake-up signal.

In some embodiments, the second time interval is any one of:

a time interval predefined by a protocol;
a time interval that is pre-set by the terminal and sent to the network device; or
a time interval that is pre-set by the network device and sent to the terminal.

In some embodiments, the first reference signal comprises a second candidate energy threshold parameter, and determining the energy threshold parameter corresponding to the wake-up signal based on the first reference signal includes:
determining the energy threshold parameter based on the second candidate energy threshold parameter.

In some embodiments, the processing module 2101 is configured to acquire information carried by the wake-up signal based on second reception energy information of the wake-up signal and the energy threshold parameter.

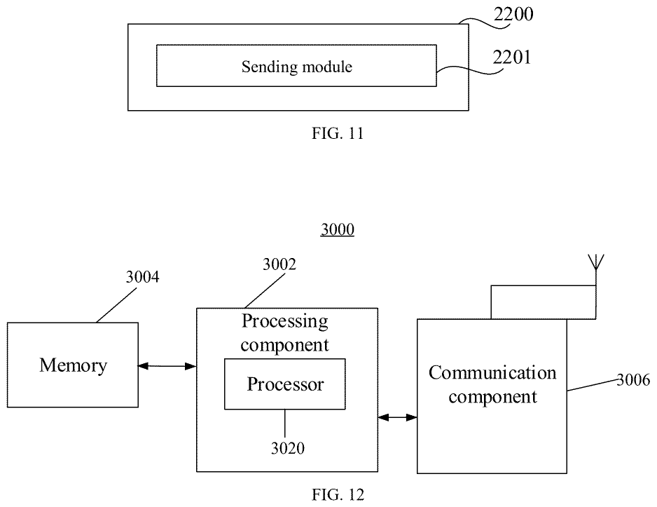

FIG. 11 is a block diagram illustrating an apparatus 2200 for information determination according to an illustrative embodiment. The apparatus may be configured in a network device. As illustrated in FIG. 11, the apparatus 2200 may include:
a sending module 2201, configured to send a wake-up signal to a terminal, in which, the wake-up signal is used to indicate the terminal to determine an energy threshold parameter corresponding to the wake-up signal based on a first reference signal, and the energy threshold parameter is used to determine information carried by the wake-up signal.

In some embodiments, the sending module 2201 is further configured to send the first reference signal to the terminal, in which, the first reference signal is different from the wake-up signal, a first time domain position of the first reference signal is located before a second time domain position of the wake-up signal, and a time interval between the first time domain position and the second time domain position is greater than or equal to a first time interval.

In some embodiments, the first time interval is any one of:
a time interval predefined by a protocol;
a time interval that is pre-set by the terminal and sent to the network device; or
a time interval that is pre-set by the network device and sent to the terminal.

In some embodiments, the first time interval is any one of:
the number of time domain symbols between a first symbol of the first reference signal and a first symbol of the wake-up signal;
the number of time domain symbols between a first symbol of the first reference signal and a last symbol of the wake-up signal;
a time interval between a last symbol of the first reference signal and a first symbol of the wake-up signal;
the number of time domain symbols between a last symbol of the first reference signal and a last symbol of the wake-up signal;
the number of slots between a slot where a first symbol of the first reference signal is located and a slot where a first symbol of the wake-up signal is located;
the number of slots between a slot where a first symbol of the first reference signal is located and a slot where a last symbol of the wake-up signal is located;
the number of slots between a slot where a last symbol of the first reference signal is located and a slot where a first symbol of the wake-up signal is located; or
the number of slots between a slot where a last symbol of the first reference signal is located and a slot where a last symbol of the wake-up signal is located.

In some embodiments, the wake-up signal includes the first reference signal and other signals, a third time domain position of the first reference signal is located before a fourth time domain position of the other signals, and a time interval between the third time domain position and the fourth time domain position is greater than or equal to a second time interval.

In some embodiments, the second time interval is any one of:
a time interval predefined by a protocol;
a time interval that is pre-set by the terminal and sent to the network device; or
a time interval that is pre-set by the network device and sent to the terminal.

In some embodiments, a sending energy of the first reference signal is a predetermined reference energy.

In some embodiments, the sending module 2201 is further configured to send the first reference signal to the terminal, in which, the first reference signal includes a second candidate energy threshold parameter, the second candidate energy threshold parameter is used to indicate the terminal to determine the energy threshold parameter.

In some embodiments, the sending module 2201 is further configured to send a first energy coefficient to the terminal, in which, the first energy coefficient is used to indicate the terminal to calculate the energy threshold parameter based on the first energy coefficient and first reception energy information of the first reference signal.

In some embodiments, the first energy coefficient is a coefficient determined based on a modulation mode of the wake-up signal, and the modulation mode includes a multi-carrier on-off keying (MC-OOK) modulation mode or an amplitude shift keying (ASK) modulation mode.

In some embodiments, in a case where the modulation mode is the MC-OOK modulation mode, the first energy coefficient is one. Or, in a case where the modulation mode is the ASK modulation mode, the first energy coefficient is more than one.

With regard to the device in above embodiment, the specific manner in which each module performs an operation is described in detail in the embodiments relating to the method, and is not described in detail herein.

FIG. 12 is a block diagram of an apparatus for information determination illustrated based on an illustrative embodiment. The apparatus 3000 may be a terminal in the communication system shown in FIG. 1 or a network device in the communication system.

As illustrated in FIG. 12, the communication device 3000 may include one or more of the following components: a processing component 3002, a memory 3004, and a communication component 3006.

The processing component 3002 may be used to control overall operation of the communication device 3000, such as operations related to display, call, data communication, camera and record. The processing component 3002 may include one or more processors 3020 to execute instructions, to achieve all or part of steps of the method for information determination. Additionally, the processing component 3002 may include one or a plurality of modules, facilitating interaction between the processing component 3002 and other components. For example, the processing component 3002 may include a multimedia module, thereby facilitating interaction between the multimedia component and the processing component 3002.

The memory 3004 is configured to store various types of data to support the operations of the communication device 3000. Examples of these data include instructions, contact data, telephone book data, messages, pictures, videos, etc. for any application or method operated on the communication device 3000. The memory 3004 may be realized by any type of volatile, or non-volatile storage devices or combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic or optical disk.

The communication component 3006 is configured to facilitate wired or wireless communication between the communication device 3000 and other devices. The communication device 3000 may access to wireless network based on communication standard, such as WiFi, 2G, 3G, 4G, 5G, 6G, NB-IOT, eMTC or combination thereof. In an illustrative embodiment, the communication component 3006 receives a broadcast signal or information related to the broadcast from an external broadcast management system. In an illustrative embodiment, the communication component 3006 further includes a near-field communication (NFC) module to promote short range communication. For example, the NFC module may be realized based on a radio frequency identification (RFID) technology, an infra-red data association (IrDA) technology, an ultra wide band (UWB) technology, a Bluetooth (BT) technology and other technologies.

In an illustrative embodiment, the communication device 3000 may be realized by one or a plurality of application specific integrated circuits (ASIC), digital signal processors (DSP), digital signal processing equipments (DSPD), programmable logic devices (PLD), field-programmable gate arrays (FPGA), controllers, microcontrollers, microprocessors or other electronic elements configured to execute the method for information determination.

The communication device 3000 may be a stand-alone electronic device or a part of a stand-alone electronic device, for example, in an embodiment, the electronic device may be an integrated circuit (IC) or a chip, where the IC may be a single IC or a collection of ICs; the chip may include, but is not limited to, the following categories: GPU (Graphics Processing Unit), CPU (Central Processing Unit), FPGA (Field Programmable Gate Array), DSP (Digital Signal Processor), ASIC (Application Specific Integrated Circuit), SOC (System on Chip), and so on. The integrated circuit or chip may be used to perform executable instructions (or codes) to implement the method for information determination. The executable instructions may be stored in the integrated circuit or chip, or may be obtained from other devices or equipment, for example, an integrated circuit or chip includes a processor, a memory, and an interface configured to communicate with the other devices. The executable instructions may be stored in the processor, and the method for information determination described above is implemented when the executable instructions are executed by the processor; alternatively, the integrated circuit or chip may receive the executable instructions through the interface and transmit them to the processor for execution, to implement the method for information determination described above.

In illustrative embodiments, the present disclosure also provides a computer-readable storage medium having stored thereon computer program instructions that, when executed by a processor, implement the steps of the method for information determination provided by the present disclosure. By way of example, the computer-readable storage medium may be a non-transitory computer-readable storage medium including instructions, such as the above-described memory 3004 including instructions, and the instructions are executable by the processor 3020 of the communication device 3000 to complete the above-described method for information determination. For example, the non-transitory computer readable storage medium may be ROM, random access memory (RAM), CD-ROM, magnetic tape, floppy disks, and optical data storage devices, among others.

In another example embodiment, the present disclosure also provides a computer program product including a computer program capable of being executed by a programmable device, the computer program has a code portion for performing the above-described method for information determination when executed by the programmable device.

Other embodiments of the present disclosure readily occur to a person skilled in the art upon consideration of the specification and practice of the present disclosure. The present application is intended to cover any variations, uses, or adaptations of the present disclosure that follow the general principles of the present disclosure and include common knowledge or conventional technical means in the art not disclosed by the present disclosure. The specification and embodiments are to be regarded as illustrative only, with the true scope and spirit of the disclosure being indicated by the following claims.

It should be understood that the present disclosure is not limited to the precise structures described above and illustrated in the accompanying drawings, and that various modifications and changes may be made without departing from the scope thereof. The scope of the present disclosure is limited only by the scope of the appended claims.

1. A method for information determination, performed by a terminal, comprising:
acquiring a first reference signal; and
determining an energy threshold parameter corresponding to a wake-up signal based on the first reference signal, wherein the wake-up signal is used to indicate the terminal to change a sleep state, and the energy threshold parameter is used to determine information carried by the wake-up signal.

2. The method according to claim 1, wherein determining the energy threshold parameter corresponding to the wake-up signal based on the first reference signal comprises:
acquiring first reception energy information of the first reference signal; and
determining the energy threshold parameter based on the first reception energy information.

3. The method according to claim 2, wherein the first reception energy information comprises a maximum energy, a minimum energy, an average energy or a specific information bit energy of the first reference signal, the specific information bit energy being a reception energy corresponding to a specific information bit carried by the first reference signal.

4. The method according to claim 2, wherein determining the energy threshold parameter based on the first reception energy information comprises:
calculating the energy threshold parameter based on the first reception energy information and a first energy coefficient; or
wherein determining the energy threshold parameter based on the first reception energy information comprises:
determining a first candidate energy threshold parameter based on the first reception energy information; and
determining the first candidate energy threshold parameter as the energy threshold parameter, or calculating the energy threshold parameter based on the first candidate energy threshold parameter and a bias parameter.

5. The method according to claim 4, wherein
the first energy coefficient is a coefficient predefined by a protocol; or
the first energy coefficient is a coefficient received from a network device; or
the first energy coefficient is a coefficient determined based on a modulation mode of the wake-up signal, wherein the modulation mode comprises a multi-carrier on-off keying (MC-OOK) modulation mode or an amplitude shift keying (ASK) modulation mode.

6. The method according to claim 2, wherein the first reference signal is a signal received via at least one reference wireless resource, and determining the energy threshold parameter based on the first reception energy information comprises:
acquiring first reception energy information corresponding to a specific information bit carried by the at least one reference wireless resource; and
determining the energy threshold parameter based on the first reception energy information.

7. The method according to claim 6, wherein
the number of reference wireless resources for receiving the first reference signal is a number predefined by a protocol; or
the number of reference wireless resources for receiving the first reference signal is a number determined based on a modulation mode of the wake-up signal, wherein the modulation mode comprises a multi-carrier on-off keying (MC-OOK) modulation mode or an amplitude shift keying (ASK) modulation mode; or
wherein the first reference signal is a synchronization portion in the wake-up signal, the synchronization portion comprises a synchronization bit sequence, and a first bit information is information in the synchronization bit sequence.

8.-9. (canceled)

10. The method according to claim 1, wherein acquiring the first reference signal comprises:
receiving the first reference signal sent by a network device, wherein the first reference signal is different from the wake-up signal, a first time domain position of the first reference signal is located before a second time domain position of the wake-up signal, and a time interval between the first time domain position and the second time domain position is greater than or equal to a first time interval.

11. The method according to claim 10, wherein the first time interval is any one of:
a time interval predefined by a protocol;
a time interval that is pre-set by the terminal and sent to the network device;
a time interval that is pre-set by the network device and sent to the terminal;
a number of time domain symbols between a first symbol of the first reference signal and a first symbol of the wake-up signal;
a number of time domain symbols between a first symbol of the first reference signal and a last symbol of the wake-up signal;
a time interval between a last symbol of the first reference signal and a first symbol of the wake-up signal;
a number of time domain symbols between a last symbol of the first reference signal and a last symbol of the wake-up signal;
a number of slots between a slot where a first symbol of the first reference signal is located and a slot where a first symbol of the wake-up signal is located;
a number of slots between a slot where a first symbol of the first reference signal is located and a slot where a last symbol of the wake-up signal is located;
a number of slots between a slot where a last symbol of the first reference signal is located and a slot where a first symbol of the wake-up signal is located; or
a number of slots between a slot where a last symbol of the first reference signal is located and a slot where a last symbol of the wake-up signal is located.

12. (canceled)

13. The method according to claim 1, wherein acquiring the first reference signal comprises:
receiving the wake-up signal sent by a network device, wherein the wake-up signal comprises the first reference signal and other signals, a third time domain position of the first reference signal is located before a fourth time domain position of the other signals, and a time interval between the third time domain position and the fourth time domain position is greater than or equal to a second time interval; and
acquiring the first reference signal based on the wake-up signal.

14. The method according to claim 13, wherein the second time interval is any one of:
a time interval predefined by a protocol;
a time interval that is pre-set by the terminal and sent to the network device; or
a time interval that is pre-set by the network device and sent to the terminal.

15. The method according to claim 1, wherein the first reference signal comprises a second candidate energy threshold parameter, and determining the energy threshold parameter corresponding to the wake-up signal according to the first reference signal comprises:
determining the energy threshold parameter based on the second candidate energy threshold parameter.

16. The method according to claim 1, further comprising:
acquiring information carried by the wake-up signal based on second reception energy information of the wake-up signal and the energy threshold parameter.

17. A method for information determination, performed by a network device, comprising:
sending a wake-up signal to a terminal, wherein the wake-up signal is used to indicate the terminal to determine an energy threshold parameter corresponding to the wake-up signal based on a first reference signal, and the energy threshold parameter is used to determine information carried by the wake-up signal.

18. The method according to claim 17, further comprising at least one of:
sending the first reference signal to the terminal, wherein the first reference signal is different from the wake-up signal, a first time domain position of the first reference signal is located before a second time domain position of the wake-up signal, and a time interval between the first time domain position and the second time domain position is greater than or equal to a first time interval;
sending the first reference signal to the terminal, wherein the first reference signal comprises a second candidate energy threshold parameter, the second candidate energy threshold parameter is used to indicate the terminal to determine the energy threshold parameter; or
sending a first energy coefficient to the terminal, wherein the first energy coefficient is used to indicate the terminal to calculate the energy threshold parameter based on the first energy coefficient and first reception energy information of the first reference signal.

19. The method according to claim 18, wherein the first time interval is any one of:
a time interval predefined by a protocol;
a time interval that is pre-set by the terminal and sent to the network device;
a time interval that is pre-set by the network device and sent to the terminal;
a number of time domain symbols between a first symbol of the first reference signal and a first symbol of the wake-up signal;
a number of time domain symbols between a first symbol of the first reference signal and a last symbol of the wake-up signal;
a time interval between a last symbol of the first reference signal and a first symbol of the wake-up signal;
a number of time domain symbols between a last symbol of the first reference signal and a last symbol of the wake-up signal;
a number of slots between a slot where a first symbol of the first reference signal is located and a slot where a first symbol of the wake-up signal is located;
a number of slots between a slot where a first symbol of the first reference signal is located and a slot where a last symbol of the wake-up signal is located;
a number of slots between a slot where a last symbol of the first reference signal is located and a slot where a first symbol of the wake-up signal is located; or
a number of slots between a slot where a last symbol of the first reference signal is located and a slot where a last symbol of the wake-up signal is located.

20. (canceled)

21. The method according to claim 17, wherein the wake-up signal comprises the first reference signal and other signals, a third time domain position of the first reference signal is located before a fourth time domain position of the other signals, and a time interval between the third time domain position and the fourth time domain position is greater than or equal to a second time interval; or
wherein a sending energy of the first reference signal is a predetermined reference energy; or
wherein the first reference signal is a signal received via at least one reference wireless resource, the number of reference wireless resources for sending the first reference signal is a number predefined by a protocol; or the number of reference wireless resources for sending the first reference signal is a number determined based on a modulation mode of the wake-up signal. wherein the modulation mode comprises a multi-carrier on-off keying (MC-OOK) modulation mode or an amplitude shift keying (ASK) modulation mode.

22. The method according to claim 21, wherein the second time interval is any one of:
a time interval predefined by a protocol;
a time interval that is pre-set by the terminal and sent to the network device; or
a time interval that is pre-set by the network device and sent to the terminal.

23.-27. (canceled)

28. A terminal, comprising:
a processor; and
a memory configured to store instructions executable by the processor,
wherein the processor is configured to acquire a first reference signal, and determine an energy threshold parameter corresponding to a wake-up signal based on the first reference signal, wherein the wake-up signal is used to indicate the terminal to change a sleep state, and the energy threshold parameter is used to determine information carried by the wake-up signal.

29. An network device, comprising:
a processor; and
a memory configured to store instructions executable by the processor,
wherein the processor is configured to performed the method according to claim 17.

30.-32. (canceled)
